(19) United States
(12) Patent Application Publication
(10) Pub. No.: US 2008/0110206 A1
(43) Pub. Date: May 15, 2008

(54) Optical element molding method and apparatus

(75) Inventors: Akiyoshi Shibasaki, Ibaraki-gun (JP); Satoshi Kurihara, Mito-shi (JP); Tadashi Horikawa, Mito-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/000,883

(22) Filed: Dec. 18, 2007

Related U.S. Application Data
(62) Division of application No. 11/299,650, filed on Dec. 13, 2005.
Application No. 11/299,650 is a continuation of application No. PCT/JP2004/008954, filed on Jun. 18, 2004.

(30) Foreign Application Priority Data
Jun. 30, 2003 (JP) 2003-186533

(51) Int. Cl. C03B 11/08; C03B 11/16

(52) U.S. Cl. 65/29.14

(57) ABSTRACT

A material for an optical element is accommodated between a first mold and a second mold, and is pressurized by relatively moving the first mold and the second mold while the material is heated to a predetermined temperature, thereby molding the optical element having a predetermined shape. This method determines, as a molding-reference distance, a distance between the first mold and the second mold of when a molding pressure which is generated between the first mold and the second mold applied to the material reaches a predetermined pressure, and moves either one of the first mold and the second mold from the molding-reference distance by a predetermined distance, thereby finishing molding of the optical element. Therefore, it is possible to reduce errors in the shapes of the final molding space easily and surely.

### CROSS REFERENCE TO RELATED APPLICATION

This is a divisional of U.S. patent application Ser. No. 11/299,650 filed Dec. 13, 2005, which is a continuation of PCT International Patent Application No. PCT/JP2004/008954 filed Jun. 18, 2004, designating the U.S., and claims the benefit of priority from Japanese Patent Application No. 2003-186533, filed on Jun. 30, 2003. The entire contents of each prior application is incorporated herein by reference.

### BACKGROUND OF THE INVENTION

1. Field of the Invention

The present invention relates to an optical element molding method and an optical element molding apparatus. More particularly, the present invention relates to an optical element molding method and an optical element molding apparatus, which pressurize a material by using a mold so as to mold an optical element having a predetermined shape.

2. Description of the Related Art

Conventionally a molding method is known which molds a glass element having a predetermined shape by accommodating a glass material between an upper mold and a lower mold and then moving the lower mold up by means of a lower shaft to pressurize the glass material while the glass material is heated to a predetermined temperature.

FIG. 11 shows this molding method. In this method, the lower mold is elevated in a molding direction from a mechanical origin Z0 of the lower shaft to a predetermined position Z1. Then the mold is heated.

After the temperature of the mold reaches a target temperature T1, the lower mold is moved up by a molding pressure P1. Molding is finished when the lower mold reaches the molding-end position Z2.

In addition, a glass element molding apparatus is conventionally known, which molds a glass element having a predetermined shape by pressurizing glass by means of a mold, as disclosed in Japanese Unexamined Patent Application Publication No. Hei 8-208247, for example.

In the above molding method shown in FIG. 11, however, the molding-end position Z2 of the lower mold is determined by regarding the mechanical origin Z0 of the lower shaft as a reference. Thus, if the height of the mold outline contains an error, the shape of the molded optical element is changed in accordance with the error.

Therefore, when a plurality of molds are used, it is conventionally necessary to make the heights of all the molds the same with high precision or give a parameter for absorbing the error to a control device.

However, processing of the molds requires a lot of time in order to make the heights of all the molds the same with high precision. Moreover, management of the molds is troublesome when the parameter for absorbing the error is given to the control device.

On the other hand, molding precisions of glass optical elements have been improving in recent years. In order to achieve the improvement, it is demanded to make rigidity of a machine higher, improve the environment of use (surrounding temperature, molding pressure, and molding temperature), and reduce errors in the molds.

The following publication describes a prior art related to the present invention.

(Patent Document 1) Japanese Unexamined Patent Application Publication No. Hei 8-208247

### SUMMARY OF THE INVENTION

It is an object of the present invention to reduce errors in the shapes of the final molding space easily and surely.

According to one aspect of an optical element molding method of the present invention, a material for an optical element is accommodated between a first mold and a second mold, and is pressurized to mold the optical element having a predetermined shape by relatively moving the first mold and the second mold while the material is heated to a predetermined temperature. This method includes the steps of determining, as a molding-reference distance, a distance between the first mold and the second mold of when a molding pressure which is generated between the first mold and the second mold applied to the material reaches a predetermined pressure, and moving either one of the first mold and the second mold from the molding-reference distance by a predetermined distance, thereby finishing molding of the optical element. Therefore, it is possible to reduce errors in the shapes of the final molding space easily and surely.

According to another aspect of the optical element molding method of the present invention, the first mold is fixed and the second mold is movable, and the molding-reference distance is determined in accordance with a position of the second mold of when the molding pressure applied to the material reaches the predetermined pressure.

According to still another aspect of the optical element molding method of the present invention, the first mold and the second mold are movable, and the molding-reference distance is determined in accordance with an interval between the first mold and the second mold of when the molding pressure applied to the material reaches the predetermined pressure.

Another aspect according to the optical element molding method of the present invention includes the steps of determining, as a molding-reference position, a position of the second mold of when a molding pressure which is generated between the first mold and the second mold applied to the material reaches a predetermined pressure, and moving the second mold from the molding-reference position by a predetermined distance, thereby finishing molding of the optical element. Therefore, it is possible to reduce errors in the shapes of the final molding space easily and surely.

According to an aspect of an optical element molding apparatus of the present invention, a control unit determines, as a molding-reference distance, a distance between a first mold and a second mold of when a pressure detected by a pressure detecting unit reaches a predetermined pressure, and controls the mold moving unit to move either one of the first mold and the second mold from the molding-reference distance by a predetermined distance. Therefore, it is possible to reduce errors in the shapes of a final molding space formed by the first mold and the second mold easily and surely.

According to another aspect of the optical element molding apparatus of the present invention, the mold moving unit moves the second mold, and the control unit determines the molding-reference distance in accordance with a position of the second mold of when a molding pressure applied to the material reaches the predetermined pressure.

According to still another aspect of the optical element molding apparatus of the present invention, the mold moving unit moves the first mold and the second mold, and the control unit determines the molding-reference distance for each of the first mold and the second mold in accordance with positions of the first mold and the second mold of when the molding pressure applied to the material reaches the predetermined pressure.

According to still another aspect of the optical element molding apparatus of the present invention, a control unit determines, as a molding-reference position, a position of the second mold of when a pressure detected by a pressure detecting unit reaches a predetermined pressure, and controls a mold moving unit to move the second mold from the molding-reference position by a predetermined distance. Therefore, it is possible to reduce errors in the shapes of the final molding space formed by the first mold and the second mold easily and surely.

According to still another aspect of the optical element molding apparatus of the present invention, the control unit includes a pressure setting unit that sets the predetermined pressure. Therefore, it is possible to easily and surely mold the optical element with higher precision by adjusting a value of a molding-reference pressure in accordance with the shape of the optical element to be molded.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is an explanatory drawing showing a first embodiment of an optical element molding apparatus according to the present invention;

FIG. 2 is an explanatory drawing showing a mold assembly used in the optical element molding apparatus shown in FIG. 1;

FIG. 3 is an explanatory drawing showing a molding method by the optical element molding apparatus shown in FIG. 1;

FIG. 4 is an explanatory drawing showing how to accommodate a material in the mold assembly shown in FIG. 2;

FIG. 5 is an explanatory drawing showing movement of an upper mold and a lower mold in the molding method shown in FIG. 3;

FIG. 6 is an explanatory drawing showing another exemplary optical element molding apparatus according to the present invention;

FIG. 7 is an explanatory drawing showing a main part of a second embodiment of an optical element molding apparatus according to the present invention;

FIG. 8 is an explanatory drawing showing a transport mechanism in FIG. 7;

FIG. 9 is an explanatory drawing showing a mold assembly used in the optical element molding apparatus shown in FIG. 7;

FIG. 10 is an explanatory drawing showing a heater and a portion around it in FIG. 7; and

FIG. 11 is an explanatory drawing showing a conventional optical element molding method.

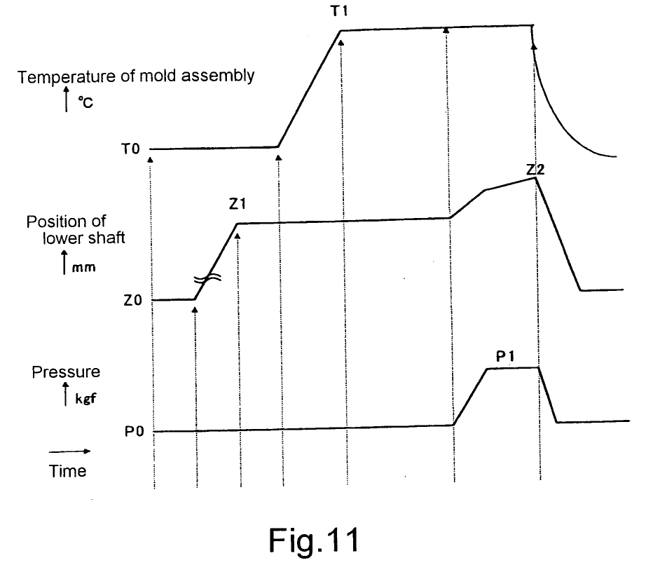

### DESCRIPTION OF THE PREFERRED EMBODIMENTS

Embodiments of the present invention are now described in detail, with reference to the drawings.

### First Embodiment

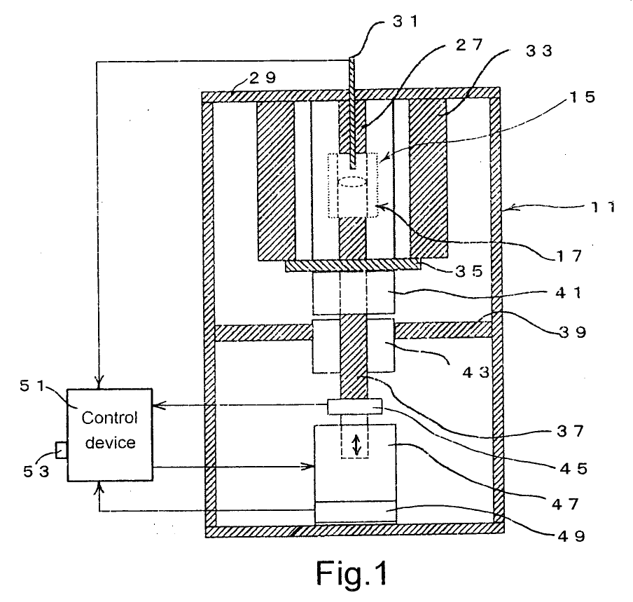

FIG. 1 shows a first embodiment of an optical element molding apparatus according to the present invention.

In this embodiment, a molding chamber 15 is provided in an upper part of an apparatus body 11. Molding is performed while a mold assembly 17 is arranged in the molding chamber 15.

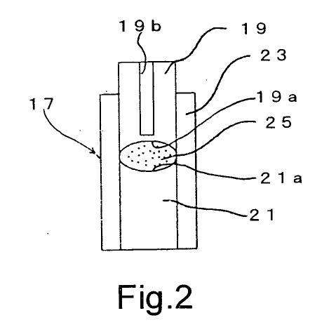

FIG. 2 shows details of the mold assembly 17. The mold assembly 17 includes an upper mold 19 and a lower mold 21. The upper mold 19 and the lower mold 21 are fitted into a cylindrical sleeve 23 so as to be freely slidable upward and downward. Concave portions 19a and 21a each having a shape corresponding to a lens to be molded are formed in a lower end face of the upper mold 19 and an upper end face of the lower mold 21, respectively. A material 25 that is formed by a glass base material is accommodated between the upper mold 19 and the lower mold 21. A thermo-couple insertion hole 19b is formed in the upper mold 19. The thermo-couple insertion hole may be formed in the lower mold 21.

In this embodiment, an upper shaft 27 is arranged above the molding chamber 15. The upper shaft 27 is fixed to a lower surface of an upper wall 29 of the apparatus body 11. An upper surface of the upper mold 19 of the mold assembly 17 can come into contact with a lower surface of the upper shaft 27. A thermo-couple 31 is arranged to run through the upper wall 29 and the upper shaft 27. A lower portion of the thermo-couple 31 can be inserted into the thermo-couple insertion hole 19b (shown in FIG. 2) formed in the upper mold 19 of the mold assembly 17.

A heating unit 33 that heats the mold assembly 17 is arranged outside the molding chamber 15. A lower end of the heating unit 33 is provided with a dividing plate 35 for sealing up the molding chamber 15 during molding. An atmosphere of inert gas formed of nitrogen is formed in the molding chamber 15. When the atmosphere of inert gas is formed in the molding chamber 15, oxidation of the mold assembly 17 can be prevented. Alternatively, the atmosphere of inert gas can be surely formed in the molding chamber 15 by using an optical element molding apparatus of a second embodiment that will be described later.

In the present embodiment, a lower shaft 37 is arranged below the molding chamber 15. A lower surface of the lower mold 21 of the mold assembly 17 can come into contact with an upper surface of the lower shaft 37. The lower shaft 37 runs through the dividing plate 35 and a supporting plate 39 and is hung down. A cooling unit 41 that cools the lower shaft 37 is arranged on a lower surface of the dividing plate 35. A lower-shaft guide 43 that guides the lower shaft 37 is arranged on the supporting plate 39. The lower-shaft guide 43 is formed by a ball bush, for example.

A pressurization detector 45 is provided below the lower-shaft guide 43 for the lower shaft 37. The pressurization detector 45 is formed by a load cell, for example. A lower-shaft pressurizing unit 47 is arranged at a lower end of the lower shaft 37. The lower-shaft pressurizing unit 47 includes a motor and a driving mechanism, although they are not shown. The motor operates the driving mechanism, thereby moving the lower shaft 37 up and down. A motor such as a servo motor can be used as that motor, for example.

A lower-shaft position detecting unit 49 that detects a position of the lower shaft 37 is arranged below the lower-shaft pressurizing unit 47. The lower-shaft position detecting unit 49 detects a pulse from an encoder (not shown) arranged on a motor shaft so as to detect the position of the lower shaft 37 from revolution and a rotational position of the motor shaft. In the present embodiment, a position of the lower mold 21 is obtained by monitoring the position of the lower shaft 37.

In FIG. 1, 51 denotes a control device that controls the aforementioned optical element molding apparatus.

A temperature signal from the thermo-couple 31, a pressure signal from the pressurization detector 45, and a lower-shaft-position signal from the lower-shaft position detecting unit 49 are input to the control device 51.

The control device 51 controls the lower-shaft pressurizing unit 47 so as to move the lower mold 21 from a molding-reference position Zs by a predetermined distance. The molding-reference position Zs is a position of the lower mold 21 when a pressure detected by the pressurization detector 45 reaches a predetermined pressure (hereinafter, referred to as a molding-reference pressure value Ps).

In the present embodiment, the control device 51 is provided with a dial 53 serving as a pressure setting unit that sets the above molding-reference pressure value Ps. The molding-reference pressure value Ps can be varied by operating the dial 53.

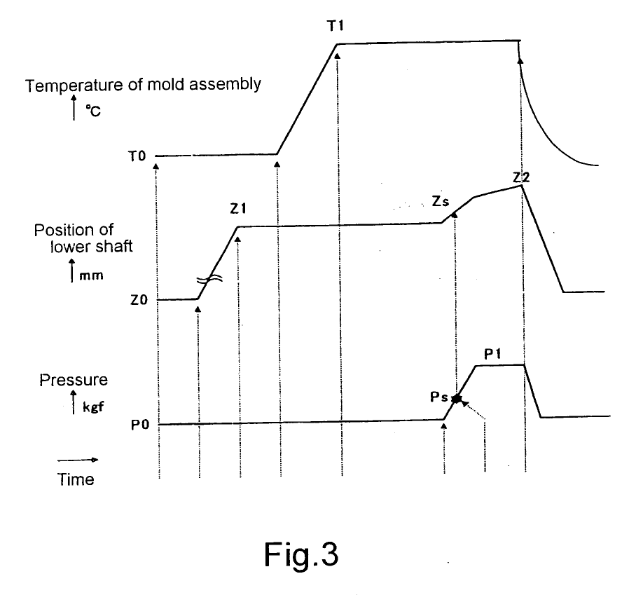

FIG. 3 shows a molding method performed by the optical element molding apparatus of the present embodiment.

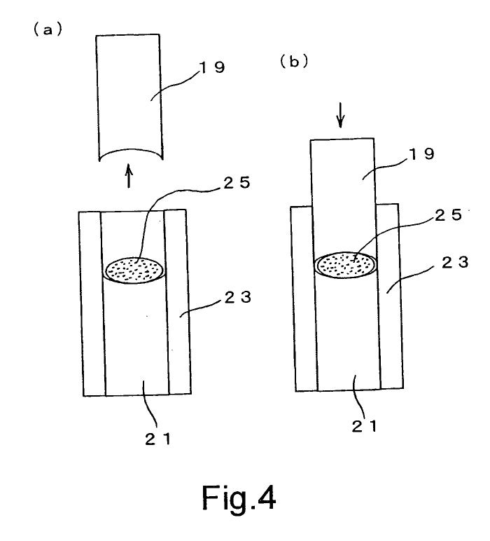

First, a material 25 formed by a glass base material is accommodated between the upper mold 19 and the lower mold 21 of the mold assembly 17 in the present embodiment. More specifically, for example, the material 25 is accommodated by removing the upper mold 19 from the sleeve 23 and putting the material 25 into the sleeve 23, as shown in FIG. 4(a), and then inserting the upper mold 19 into the sleeve 23 so as to fit the upper mold 19 with the sleeve 23, as shown in FIG. 4(b).

Then, the mold assembly 17 with the material 25 accommodated therein is accommodated in the molding chamber 15 through a carry-in port (not shown) for the mold assembly 17 that is formed in the heating unit 33 and the molding chamber 15. The mold assembly 17 with the material 25 accommodated therein can be easily and surely carried in and out into/from the molding chamber 15 by using the optical element molding apparatus of the second embodiment that will be described later.

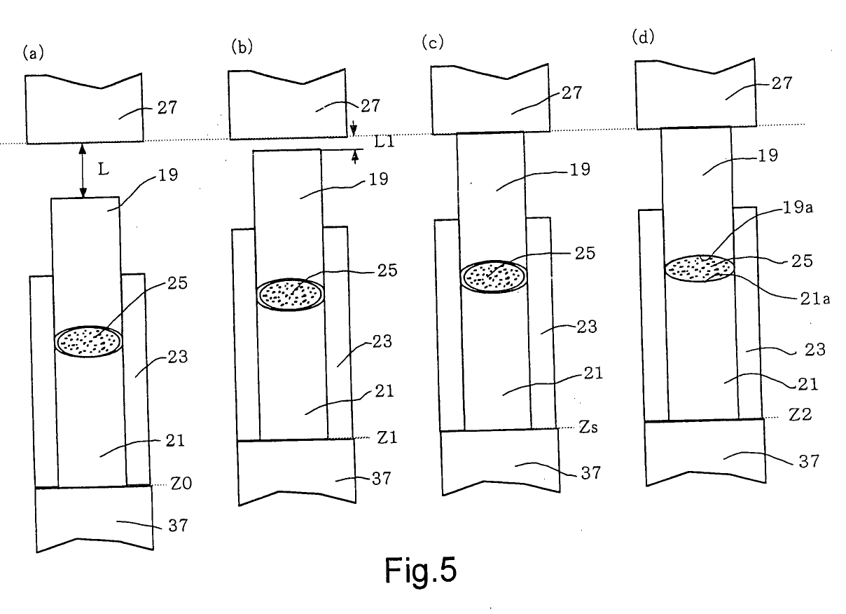

In this state, the lower end of the lower mold 21 is in contact with the upper end of the lower shaft 37 and a gap L that is sufficiently wide to allow for an easy operation is formed between the upper shaft 27 and the mold assembly 17, as shown in FIG. 5(a). A temperature of the mold assembly 17 is a normal temperature T0 in this state, as shown in FIG. 3. A position of the upper end of the lower shaft 37 in this state is assumed as Z0. Moreover, no molding pressure acts on the lower shaft 37 and a pressure detected by the pressurization detector 45 is assumed as P0.

Then, the upper end of the lower shaft 37 is elevated to a molding-heating position Z1, as shown in FIG. 3. In this state, the lower end of the lower mold 21 is in contact with the upper end of the lower shaft 37 and a small gap L1 is formed between the upper end of the upper mold 19 and the upper shaft 27, as shown in FIG. 5(b).

After a predetermined time passes, the heating unit 33 begins to heat the mold assembly 17. The temperature of the mold assembly 17 is input to the control device 51 through the thermo-couple 31. The control device 51 controls the heating unit 33 to heat the mold assembly 17 until the temperature from the thermo-couple 31 reaches a molding temperature T1 and then keep the molding temperature T1.

After the mold assembly 17 is kept at the molding temperature for a predetermined time, the lower-shaft pressurizing unit 47 moves the lower shaft 37 up at a predetermined rate. This movement of the lower shaft 37 moves the lower mold 21 up. Therefore, an interval between the upper mold 19 and the lower mold 21 becomes small, thus increasing a pressure value input from the pressurization detector 45 to the control device 51.

The control device 51 determines the position of the lower mold 21 when the thus input pressure value reaches a predetermined molding-reference pressure value Ps as a molding-reference position Zs. In this state, the lower end of the lower mold 21 is in contact with the upper end of the lower shaft 37 and the upper end of the upper mold 19 is in contact with the upper shaft 27, as shown in FIG. 5(c).

The control device 51 then controls the lower-shaft pressurizing unit 47 to move the lower mold 21 from the molding-reference position Zs by a predetermined distance.

More specifically, when a molding-end position of the upper end of the lower shaft 37 is assumed as Z2, the predetermined distance is Z2-Zs. The control device 51 moves the lower shaft 37 by that distance. Please note that the distance from the molding-reference position Zs to the molding-end position Z2 can be set in the control device 51 in advance.

In the present embodiment, the lower-shaft pressurizing unit 47 is subjected to torque control and the lower shaft 37 is moved up at a predetermined rate until the pressure value reaches a predetermined molding pressure value P1, as shown in FIG. 3. After the pressure value reaches the predetermined molding pressure value P1, the lower shaft 37 is moved to the molding-end position Z2 while the molding pressure value P1 is maintained.

FIG. 5(d) shows a state of the upper and lower molds 19 and 21 after the upper end of the lower shaft 37 is moved to the molding-end position Z2. In this state, a shape of a final molding space formed by the concave portions 19a and 21a of the upper and lower molds 19 and 21 contains almost no error and therefore an optical element formed by a glass lens is molded with high precision.

Then, the lower-shaft pressurizing unit 47 moves the position of the upper end of the lower shaft 37 down to the position Z0, as shown in FIG. 3. At the same time, heating by the heating unit 33 is stopped and the mold assembly 17 is cooled by inert gas formed of nitrogen that is supplied to the molding chamber 15. The mold assembly 17 is brought out from the molding chamber 15 after being cooled.

In the above embodiment, the position of the lower mold 21 when the pressure detected by the pressurization detector 45 reaches the molding-reference pressure value Ps is determined as the molding-reference position Zs. The lower-shaft pressurizing unit 47 is controlled to move the lower mold 21 from the thus determined molding-reference position Zs by a predetermined distance. Thus, it is possible to reduce generation of an error in the shape of the final molding space formed by the concave portions 19a and 21a of the upper and lower molds 19 and 21 easily and surely. Therefore, an optical element formed by a glass lens can be easily and surely molded with high precision.

In other words, it is possible to absorb thermal expansion of the apparatus itself caused by heating, distortion of the apparatus itself caused by pressurization, and an error in a length of the mold assembly 17 in the pressing direction by determining the molding-reference position Zs after heating and pressurization in the above embodiment. Moreover, a use condition can be also eased in terms of a surrounding temperature and humidity in a use environment and a temperature and a flow rate of cooling water. In addition, if repeat accuracy of the optical element molding apparatus is good, it is possible to mold lenses with high precision even when the strength of the/device is lowered.

When a plurality of mold assemblies 17 are used, it is not necessary to make the heights of all the mold assemblies 17 the same with high precision or give a parameter for absorbing an error to the control device 51.

In the above embodiment, the control device 51 is provided with the dial 53 serving as a pressure setting unit that sets the molding-reference pressure value Ps. Therefore, it is possible to easily and surely mold an optical element with higher precision by adjusting the molding-reference pressure value Ps within a region of P0<Ps<P1 in accordance with the shape of the optical element to be molded.

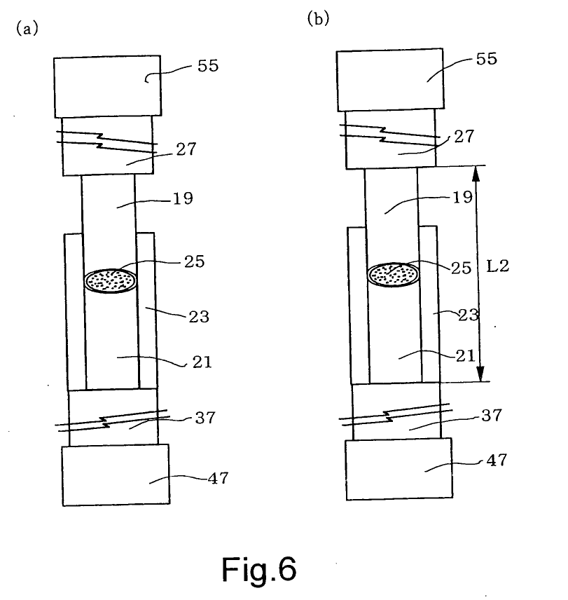

In the above embodiment, an example is described in which the upper mold 19 is fixed, the position of the lower mold 21 when the pressure detected by the pressurization detector 45 reaches the molding-reference pressure value Ps is determined as the molding-reference position Zs, and the lower-shaft pressurizing unit 47 is controlled to move the lower mold 21 from the molding-reference position Zs by a predetermined distance. However, the present invention is not limited thereto. For example, as shown in FIG. 6(a), the upper mold 19 may be arranged to be positively movable down by an upper-shaft pressurization unit 55, so that molding is performed by moving both the upper and lower molds 19 and 21.

In this case, as shown in FIG. 6(b), a distance L2 between the upper mold 19 and the lower mold 21 when the pressure detected by the pressurization detector 45 reaches the molding-reference pressure value Ps is determined as a molding-reference distance. Molding is performed by moving the upper mold 19 and the lower mold 21 from the thus determined molding-reference distance L2 by a predetermined distance. The molding-reference distance L2 is obtained as a difference between the position of the upper end face of the upper mold 19 and the position of the lower end face of the lower mold 21 that are obtained from an upper-shaft position detecting unit and a lower-shaft position detecting unit (not shown), respectively.

In the above embodiment, an example is described in which the present invention is applied to molding of a glass lens. However, the present invention is not limited thereto. The present invention can be widely applied to molding of a lens made of resin or the like or molding of various optical elements, for example.

### Second Embodiment

A second embodiment of the present invention is now described in detail, with reference to the drawings.

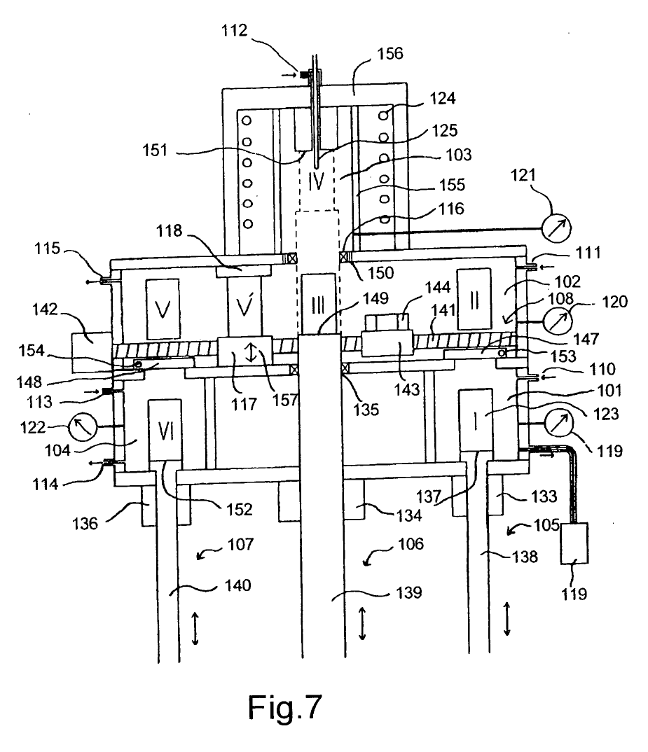

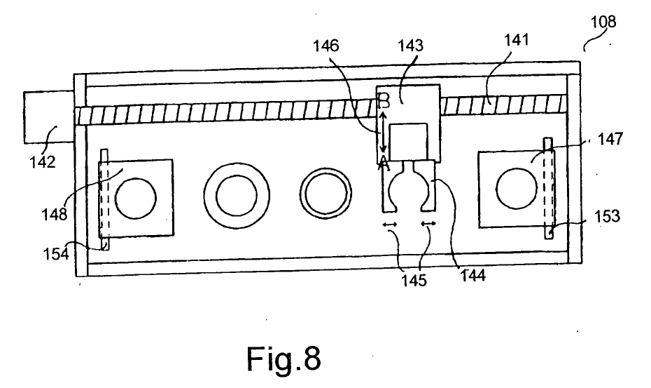

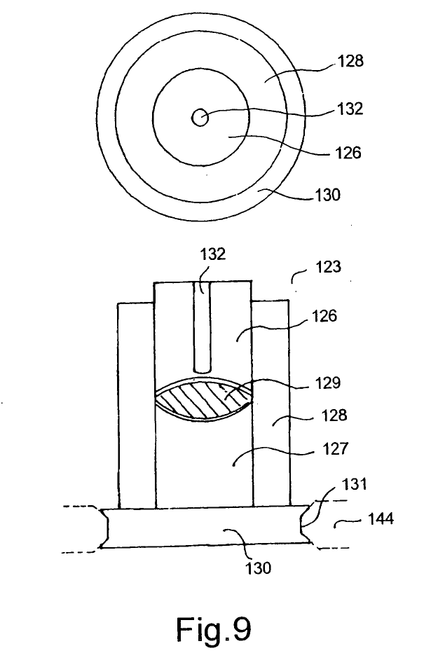

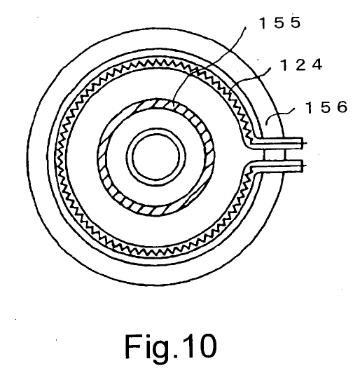

FIG. 7 shows an inner cross section of a main part of an optical element molding apparatus of the present embodiment. FIG. 8 shows a transport mechanism 108. FIG. 9 shows a mold assembly 123. FIG. 10 shows a heating mechanism. The optical element molding apparatus of the second embodiment of the present invention is described with reference to FIGS. 7, 8, 9, and 10.

In the second embodiment, an arrangement for carrying in and out the mold assembly 123 with a material accommodated therein to/from a molding chamber and an arrangement for forming an atmosphere of inert gas in a molding part are mainly described. An arrangement and a control method for moving a lower shaft 139 and the like are the same as those in the first embodiment and therefore the detailed description thereof is omitted.

In FIG. 7, the optical element molding apparatus of the present embodiment includes a supply chamber 101, an intermediate chamber 102, a molding chamber 103, a bring-out chamber 104, transport mechanisms 105, 107, and 108, and a molding and transport mechanism 106. Reference signs I, II, III, IV, V, V′, and VI denote positions of the mold assembly 123.

The supply chamber 101 of the optical element molding apparatus of the present embodiment includes a vacuum pump 109 such as a rotary pump, an inert gas introducing unit 110, a pressure gauge 119, a dividing valve 147, and a front door (not shown) for setting the mold assembly 123 in the supply chamber 101 from the outside.

Position I in FIG. 7 is a position at which the mold assembly 123 is placed from the outside. The dividing valve 147 is closed by rotating its valve body around an opening and closing axis 153 counterclockwise. Then, the mold assembly 123 is placed at Position I and the front door is closed to seal the supply chamber 101. When the vacuum pump 109 is operated in this state, a vacuum atmosphere can be created in the supply chamber 101.

When the inside of the supply chamber 101 becomes vacuum, evacuation of an air is stopped and inert gas is introduced through the gas introducing unit 110. In this manner, an atmosphere of inert gas can be formed in the supply chamber 101 and oxygen can be removed from the mold assembly 123. Since a pressure of the inert gas in the supply chamber 101 can be measured by the pressure gauge 119, it is possible to adjust the atmosphere of inert gas in the supply chamber 101 to have a desired pressure by adjusting a gas flow rate of the inert gas introducing unit 110.

The atmosphere in the supply chamber 101 is replaced with the air when the front door is opened. However, the volume of the supply chamber 101 is small with respect to the entire volume of the molding apparatus. Therefore, the consumed amount of the inert gas can be reduced. When a transport shaft 138 is elevated in order to move the mold assembly 123 from Position I to Position II, the dividing valve 147 is opened by rotating the valve body around the opening and closing axis 153 clockwise.

The intermediate chamber 102 of the optical element molding apparatus of the present embodiment includes Positions III, V′, and V, cooling mechanisms 117 and 118, an inert gas introducing unit 111, an inert gas discharging unit 115, and a pressure gauge 120 for measuring a pressure inside the intermediate chamber 102.

Position II in FIG. 7 is a position at which the transport mechanism 108 receives the mold assembly 123 that is transported from Position I in the supply chamber 101 by the elevation of the transport shaft 138. Position III is a position at which the mold assembly 123 transported by the transport mechanism 108 is handed to the molding and transport mechanism 106. Position V′ is a position at which the mold assembly 123 after molding is cooled. Position V is a position at which the mold assembly 123 transported by the transport mechanism 108 after cooling is handed to the transport mechanism 107.

The pressure inside the intermediate chamber 102 can be adjusted to a desired pressure by adjusting the amount of gas introduced through the inert gas introducing unit 111 and the amount of gas discharged through the inert gas discharging unit 115 while the pressure gauge 120 measures the pressure.

The cooling mechanisms 117 and 118 are formed by water-cooled metal blocks. The transport mechanism 108 places the mold assembly 123 in the cooling mechanism 117. The cooling mechanism 117 is then elevated, as shown with an arrow 157. While the cooling mechanisms 117 and 118 are in contact with an upper surface and a lower surface of the mold assembly 123 with pressure, respectively, cooling by thermal conduction is performed.

The molding chamber 103 of the optical element molding apparatus of the present embodiment includes an inert gas introducing unit 112, a shaft seal 116, a gas flow channel 150, a pressure gauge 121, a heater 124, and a thermo-couple 125.

Position IV in FIG. 7 is a position for performing replacement of inert gas, heating of the mold assembly 123, and molding. Inert gas inside the molding chamber 103 can be adjusted to have a desired pressure by adjusting the inert gas introducing unit 112 while the pressure gauge 121 measures the pressure of the inert gas.

The gas flow channel 150 is formed by a plurality of small holes provided around the shaft seal 116 so as to make the molding chamber 103 and the intermediate chamber 102 communicate with each other. The number and size of those holes are determined so as to prevent the pressure inside the molding chamber 103 from becoming excessively large and achieve conductance that maintains an appropriate pressure difference between the molding chamber 103 and the intermediate chamber 102.

The heater 124 heats the mold assembly 123 placed at Position IV for heating and molding, while the thermo-couple 125 measures a temperature of the mold assembly 123. In this manner, a glass material is heated to have a viscosity that is suitable for molding.

The bring-out chamber 104 of the optical element molding apparatus of the present embodiment includes an inert gas introducing unit 113, an inert gas discharging unit 114, a pressure gauge 122, a dividing valve 148, and a front door (not shown) for bringing out the mold assembly 123 to the outside of the optical element molding apparatus.

Position VI in FIG. 7 is a position at which the mold assembly 123 that is transported from the intermediate chamber 102 by downward movement of a transport shaft 140 is held in order to be brought out to the outside.

In the bring-out chamber 104, the dividing valve 148 is closed by rotating its valve body around an opening and closing axis 154 clockwise and the front door is closed. In this state, evacuation pumps connected to the inert gas introducing unit 113 and the inert gas discharging unit 114 are adjusted while the pressure gauge 122 measures the pressure in the bring-out chamber 104. In this manner, an atmosphere of inert gas having a desired pressure can be formed in the bring-out chamber 104.

Moreover, it is possible to always generate a flow of the inert gas introduced through the inert gas introducing unit 113 to the bring-out chamber 104 by controlling the evacuation pump connected to the inert gas discharging unit 114. Thus, it is difficult for oxygen to reach the molding chamber 103 even if the bring-out chamber 104 is opened to the air.

It is preferable that the volume of the bring-out chamber 104 be as small as possible in order to reduce the consumed amount of the inert gas. When the mold assembly 123 is moved down from Position V to Position VI by moving the transport shaft 140 down, the dividing valve 148 is opened by rotating the valve body around the opening and closing axis 154 counterclockwise.

In the present embodiment, the mold assembly 123 is arranged as shown in FIG. 9. The mold assembly 123 is now described, with reference to FIG. 9.

The mold assembly 123 includes an upper mold 126, a lower mold 127, a sleeve 128, a base material of glass 129, and a transport table 130.

The lower mold 127, the glass base material 129, and the upper mold 126 are fitted into the sleeve 128 in that order so as to be movable up and down along an inner wall of the sleeve 128.

The sleeve 128, the upper mold 126, the glass base material 129, and the lower mold 127 are placed on the transport table 130. The transport table 130 is provided with dents 131 for transport in its side faces. The dents 131 for transport are used when the transport mechanism 108 transports the mold assembly 123 in the intermediate chamber 102.

The upper mold 126 has an insertion hole 132 for the thermo-couple 125. A temperature of the upper mold 126 can be measured by inserting the thermo-couple 125 into the insertion hole 132. The lower mold 127 may have an insertion hole that is similar to that formed in the upper mold 126, while the transport table 130 may have a hole that can be in connection with the insertion hole of the lower mold 127, so that a thermo-couple can be inserted into the holes and a temperature of the lower mold 127 can be measured.

Next, the transport mechanisms 105, 106, 107, and 108 of the optical element molding apparatus of the present embodiment are described.

FIG. 8 is a top view of the transport mechanism 108. Referring to FIGS. 8 and 7, the transport mechanism 108 is described.

The transport mechanism 108 is arranged to move the mold assembly 123 from Position II to Position II, from Position III to Position V′, and from Position V′to Position V.

The transport mechanism 108 is also arranged to receive the mold assembly 123 that is transported from Position I by the transport mechanism 105 at Position II. The transport mechanism 108 is arranged to hand the mold assembly 123 to the molding and transport mechanism 106 and receive the mold assembly 123 after molding from the molding and transport mechanism 106 at Position III. The transport mechanism 108 is arranged to hand the mold assembly 123 after molding to the cooling mechanism 117 and receive the mold assembly 123 after cooling from the cooling mechanism 117 at Position V′. The transport mechanism 108 is arranged to hand the mold assembly 123 to the transport mechanism 107 at Position V.

A main part of a body of the transport mechanism 108 is provided in the intermediate chamber 102 in the optical element molding apparatus of the present embodiment. The transport mechanism 108 includes a ball screw 141, a moving mechanism 143 screwed with the ball screw 141, and a motor 142 for rotating the ball screw 141.

The moving mechanism 143 has a grasping unit 144 at its top end and can open and close the grasping unit 144 in a direction shown with 145 by means of an opening and closing mechanism (not shown). The grasping unit 144 has a structure that allows the grasping unit 144 to move in a direction shown with an arrow 146 by itself.

FIG. 8 shows a grasping position when the grasping unit 144 moves toward a direction A. The grasping unit 144 moves to the direction A and then grasps the mold assembly 123. Then, transport of the mold assembly 123 between Positions II and V is performed. After that transport, the grasping unit 144 moves toward a direction B to leave. Thus, the moving mechanism 143 can be moved between Positions II and V without interference.

A method for receiving the mold assembly 123 by the transport mechanism 108 is now described based on the following specific example.

The transport mechanism 108 operates in the following manner at Position II, thereby receiving the mold assembly 123 transported from the supply chamber 101.

The moving mechanism 143 moves to Position II while the grasping unit 144 is opened and is moved back toward the direction B. At Position II, the mold assembly 123 is waiting as a result of elevation of the transport shaft 138. In this state, the grasping unit 144 is moved toward the direction A and is then closed to sandwich the mold assembly 123 at the transport dents 131. In this manner, the grasping unit 144 grasps the mold assembly 123. Then, the transport shaft 138 can be moved down. This grasping state is shown in FIG. 9. The mold assembly 123 is transported by rotating the motor 142 to move the mold assembly 123 to the left, while being grasped.

A method for handing the mold assembly 123 by the transport mechanism 108 is now described based on the following specific example.

The transport mechanism 108 operates in the following manner at Position III, thereby handing the mold assembly 123 transported from the supply chamber 101.

The moving mechanism 143 moves to Position III, while the grasping unit 144 is closed and grasps the mold assembly 123. At Position III, the transported mold assembly 123 is located above a top 149 of the molding and transport mechanism 106. In this state, the grasping unit 144 of the moving mechanism 143 is opened to release grasping of the mold assembly 123, thereby placing the mold assembly 123 on the top 149.

After the mold assembly 123 is handed in the above manner, the moving mechanism 143 moves the grasping unit 144 toward the leaving direction B. Then, the moving mechanism 143 moves to the next transport position. The moving mechanism 143 can be moved to the left by rotating the motor 142 in a normal direction or to the right by rotating the motor 142 in a reverse direction.

Methods for handing and receiving the mold assembly 123 at Positions V and V′ are generally the same as those described above and therefore the description thereof is omitted.

The transport mechanism 105 of the present embodiment includes the transport shaft 138, a guiding and sealing mechanism 133, and a pneumatic cylinder mechanism (not shown).

The mold assembly 123 is placed on a top 137 of the transport shaft 138 and the dividing valve 147 is opened by rotating the valve body around the opening and closing axis 153 clockwise. In this state, the transport shaft 138 is elevated along the guiding and sealing mechanism 133 so as to transport the mold assembly 123 from Position I in the supply chamber 101 to Position II in the intermediate chamber 102. After the transport, the top 137 of the transport shaft 138 is moved back to Position I.

The molding and transport mechanism 106 of the optical element molding apparatus of the present embodiment includes a lower shaft 139, a guiding mechanism 134, a pneumatic cylinder mechanism (not shown), and shaft seals 135 and 116.

In order for the molding and transport mechanism 106 to perform transport, the lower shaft 139 on which the mold assembly 123 handed from the transport mechanism 108 at Position III in the intermediate chamber 102 is placed at the top 149 is elevated along the guiding mechanism 134 from Position III to Position IV in the molding chamber 103. As a result of this elevation, the thermo-couple 125 is inserted into the thermo-couple insertion hole 132 of the mold assembly 123 and measurement of the temperature of the mold assembly 123 during molding is made possible. In this state, the upper surface of the upper mold 126 has not come into contact with a contact surface 151 yet. Supply of inert gas and heating of the mold assembly 123 are performed in this state. After the supply of inert gas and the heating are finished, molding is performed.

In order to perform the molding, the lower shaft 139 is further moved up from the position when the transport is finished, so as to bring the upper mold 126 into contact with the contact surface 151. Moreover, a driving force for elevating the lower shaft 139 is further applied, thereby relatively moving the upper mold 126 and the lower mold 127 with respect to the glass base material 129. As a result, the upper mold 126 and the lower mold 127 are in close contact with the glass base material 129 and therefore the glass base material 129 is molded. After the molding, the top 149 of the lower shaft 139 is moved down so as to bring the mold assembly 123 back to Position III.

As described above, the molding chamber 103 is provided above the intermediate chamber 102, and the molding and transport mechanism 106 can perform both transport of the mold assembly 123 between the intermediate chamber 102 and the molding chamber 103 and pressurization to the upper mold 126 and the lower mold 127 of the mold assembly 123 by means of the same member. Therefore, it is possible to obtain an inexpensive optical element molding apparatus that occupies as little space as possible. Moreover, inert gas is introduced into the molding chamber 103 during molding. When only introduction of the inert gas into the molding chamber 103 is performed in accordance with the conventional technique, parts inside the molding chamber 103 are oxidized during molding because oxygen remains inside the molding chamber. On the other hand, in the optical element molding apparatus of the present invention, oxygen is removed as much as possible by evacuating the supply chamber 101 once. Therefore, it is possible to prevent occurrence of oxidation during molding as much as possible.

The transport mechanism 107 of the optical element molding apparatus of the present embodiment includes a transport shaft 140, a guiding mechanism 136, and a pneumatic cylinder mechanism (not shown).

In order to perform transport, the dividing valve 148 is opened by rotating the valve body around the opening and closing axis 154 counterclockwise. In this state, the transport shaft 140 on which the mold assembly 123 that is handed from the transport mechanism 108 at Position V in the intermediate chamber 102 is placed at a top 152 is moved down from Position V to Position VI in the bring-out chamber 104. It is possible to detach the mold assembly 123 from the top 152 when the front door of the bring-out chamber 104 is opened.

In the optical element molding apparatus of the present embodiment, a pressure difference is provided between the intermediate chamber 102 and the supply chamber 101, between the molding chamber 103 and the intermediate chamber 102, and between the intermediate chamber and the bring-out chamber 104 in order to perform heating of the mold assembly 123 and molding under a condition in which activated gas such as oxygen is reduced as much as possible.

More specifically, the pressure inside the intermediate chamber 102 is made higher than that inside the supply chamber 101 in order to reduce the amount of the activated gas such as oxygen flowing from the supply chamber 101 to the intermediate chamber 102 when the mold assembly 123 is transported from the supply chamber 101 to the intermediate chamber 102 in the optical element molding apparatus of the present embodiment, for example. As the pressure difference between the intermediate chamber 102 and the supply chamber 101 becomes larger, the effect of preventing the inflow of the activated gas is enhanced. However, an excessively large pressure difference is not preferable because inert gas begins to blow when the dividing valve 147 is opened. Moreover, in the case where the pressure difference is too large, the amount of inert gas that escapes when the front door of the supply chamber 101 is opened and the mold assembly 123 is set increases. In terms of this point, an excessively large pressure difference is not preferable.

The above can be also applied to a case where the mold assembly 123 is brought out from the bring-out chamber 104 to the outside. On the other hand, an excessively small pressure difference lowers the effect of preventing the inflow of the activated gas. A preferable pressure difference is 1 hPa or more and 10 hPa or less. For the same reasons, it is preferable that the pressure inside the molding chamber 103 be higher than that inside the intermediate chamber 102 by a pressure difference of 1 hPa or more and 10 hPa or less. Similarly, it is preferable that the pressure inside the intermediate chamber 102 be higher than that inside the bring-out chamber 104 by a pressure difference of 1 hPa or more and 10 hPa or less.

The dividing valves 147 and 148 are provided between the intermediate chamber 102 and the supply chamber 101 and between the intermediate chamber 102 and the bring-out chamber 104, respectively, thereby suppressing useless consumption of the inert gas in the intermediate chamber 102. Especially, the supply chamber 101 is evacuated in order to remove oxygen from the mold assembly 123. It is possible to suppress useless discharge of the inert gas during the evacuation.

In the above arrangement, it is possible to make purity of the inert gas in the intermediate chamber 102 higher than those in the supply chamber 101 and the bring-out chamber 104. It is also possible to make purity of the inert gas in the molding chamber 103 higher than that in the intermediate chamber 102.

Please note that the pressure in each of the supply chamber 101 and the bring-out chamber 104 should be an atmospheric pressure when the mold assembly 123 is set and is brought out. In order to achieve the above, it is preferable to set the pressure of the inert gas in each of the supply chamber 101 and the bring-out chamber 104 to be approximately the same as the atmospheric pressure.

In order to perform the pressure adjustment described above, a pressure controller or a gas-flow controller is provided for each of the inert gas introducing units 110, 111, 112, and 113 and a gas-flow controller is provided for the inert gas discharging units 114 and 115 in the optical element molding apparatus of the present embodiment.

It is preferable that the inert gas used in the optical element molding apparatus of the present embodiment be highly pure nitrogen gas from a viewpoint of the amount of money that is spent. Alternatively, highly pure rare gas such as argon or neon may be used, if necessary.

The optical element molding apparatus of the present embodiment performs molding in the following procedure. The molding procedure is described based on FIGS. 7, 8, 9, and 10.

(1) First, the mold assembly 123 is set at Position I in the supply chamber 101 by hand or an automatic supplying machine.

(2) The supply chamber 101 is evacuated by the vacuum pump 109. When the inside of the supply chamber 101 becomes vacuum, evacuation is stopped.

(3) Inert gas is introduced through the inert gas introducing unit 110 and the pressure difference between the supply chamber 101 and the intermediate chamber 102 is set to a predetermined pressure value. In this state, the dividing valve 147 is opened, and the transport mechanism 105 transports the mold assembly 123 from Position I to Position II and then hands it to the transport mechanism 108 at Position II. After the mold assembly 123 is handed, the top 137 of the transport mechanism 105 is brought back to the supply chamber 101 and the dividing valve 147 is closed.

(4) The transport mechanism 108 transports the mold assembly 123 to Position III and hands it to the molding and transport mechanism 106 there.

(5) The molding and transport mechanism 106 moves the mold assembly 123 from Position III to Position IV. Replacement of inert gas and heating of the mold assembly 123 are performed at Position IV. After the replacement of inert gas and the heating are finished, molding is performed.

(6) After molding is finished, the lower shaft 139 is moved down to move the mold assembly 123 from Position IV to Position Ill.

(7) The molding and transport mechanism 106 hands the mold assembly 123 to the transport mechanism 108 at Position Ill.

(8) The transport mechanism 108 transports the mold assembly 123 after molding from Position III to Position V′.

(9) The transport mechanism 108 hands the mold assembly 123 to the cooling mechanism 117 at Position V′. The cooling mechanisms 117 and 118 then cool the mold assembly 123.

(10) The transport mechanism 108 receives the mold assembly 123 after cooling from the cooling mechanism 117 and then transports it from Position V to Position V.

(11) The transport mechanism 108 hands the mold assembly 123 to the transport mechanism 107 at Position V.

(12) The transport mechanism 107 transports the mold assembly 123 from Position V to Position VI while the dividing valve 148 is opened. After the transport of the mold assembly 123 is finished, the dividing valve 148 is closed.

(13) While the mold assembly 123 is located at Position VI, the front door is opened. Then, the mold assembly 123 for which the molding process has been finished is brought out to the outside.

The aforementioned four processes, i.e., (i) the process at Positions I and II, (ii) the process at Positions III and IV, (iii) the process at Position V′, and (iv) the process at Positions V and VI can be performed without interfering with each other. In other words, those four processes can be performed in parallel. Thus, the optical element molding apparatus of the present embodiment can process four mold assemblies in parallel at the same time. Therefore, the number of products manufactured by the optical element molding apparatus of the present embodiment is large (i.e., throughput is high).

Moreover, the pressure difference between the molding chamber 103 and the outside is set in two stages in order to prevent the molding chamber 103 from being exposed to the air in the optical element molding apparatus of the present embodiment. More specifically, the pressure difference is set in such a manner that the pressure in the molding chamber 103 is higher than that in the intermediate chamber 102 and that in the intermediate chamber 102 is higher than that in each of the supply chamber 101 and the bring-out chamber 104. In addition, after the mold assembly is set in the supply chamber 101, the supply chamber 101 is evacuated once so as to remove activated gas such as oxygen and thereafter an atmosphere of inert gas is formed. Thus, the amount of the activated gas such as oxygen flowing into the atmosphere of inert gas in the molding chamber 103 when the mold assembly is set and is brought out is very small. Therefore, almost no oxidation of the upper and lower molds 126 and 127 occurs. Accordingly, an optical element that is molded by using the optical element molding apparatus of the present embodiment in the aforementioned processes has no loss of transparency of an optical surface that is a molded surface.

The optical element molding apparatus of the present embodiment performs molding by using the mold assembly 123. In the mold assembly 123, the sleeve 128 serves as guides for the upper and lower molds 126 and 127, as is apparent from FIG. 9. Therefore, tilt of each of the upper and lower molds 126 and 127 is small, and the molded optical element is less eccentric, as compared with that molded by a conventional optical element molding apparatus.

The optical element molding apparatus of the present embodiment can obtain the same effects as those obtained in the first embodiment. Moreover, a high-quality optical element that has no loss of transparency and is less eccentric can be molded in the present embodiment.

The present invention was described above in detail. However, the invention is not limited to the above embodiments and various modifications may be made without departing from the spirit and scope of the invention. Any improvement may be made in part or all of the components.

What is claimed is:

1. An optical element molding method accommodating a material for an optical element between a first mold and a second mold, and pressurizing said material to mold an optical element having a predetermined shape by relatively moving said first mold and said second mold while heating said material to a predetermined temperature, comprising the steps of:
determining, as a molding-reference distance, a distance between said first mold and said second mold of when a molding pressure which is generated between said first mold and said second mold applied to said material reaches a predetermined pressure; and
moving either one of said first mold and said second mold from the molding-reference distance by a predetermined distance, thereby finishing molding of said optical element.

2. The optical element molding method according to claim 1, wherein:
said first mold is fixed and said second mold is movable; and
said molding-reference distance is determined in accordance with a position of said second mold of when the molding pressure applied to said material reaches the predetermined pressure.

3. The optical element molding method according to claim 1, wherein:
said first mold and said second mold are movable; and
said molding-reference distance is determined in accordance with an interval between said first mold and said second mold of when the molding pressure applied to said material reaches the predetermined pressure.

4. An optical element molding method accommodating a material for an optical element between a first mold and a second mold, and pressurizing said material to mold an optical element having a predetermined shape by moving said second mold while heating said material to a predetermined temperature, comprising the steps of:
determining, as a molding-reference distance, a position of said second mold of when a molding pressure which is generated between said first mold and said second mold applied to said material reaches a predetermined pressure; and
moving said second mold from the molding-reference position by a predetermined distance, thereby finishing molding of said optical element.
